(19) United States
(12) Patent Application Publication
(10) Pub. No.: US 2025/0246382 A1
(43) Pub. Date: Jul. 31, 2025

(54) INTELLIGENT KNOB

(71) Applicant: Guangdong Jinfu Intelligent Technology Co., Ltd, Dongguan (CN)

(72) Inventors: Guosheng ZENG, Dongguan (CN); Chengteng LIANG, Dongguan (CN); Shengkai HUANG, Dongguan (CN)

(21) Appl. No.: 18/666,726

(22) Filed: May 16, 2024

(30) Foreign Application Priority Data
Jan. 29, 2024 (CN) 2024101176315

(51) Int. Cl. H01H 19/14; H01H 19/02; H01H 19/04

(52) U.S. Cl. CPC H01H 19/14; H01H 19/025; H01H 19/04

(57) ABSTRACT

An intelligent knob includes: a bottom housing, a rotating assembly, an inner support assembly, a small gear, a PCBA, a display module, a knob outer ring, and a permanent magnet. An upper side of the bottom housing defines an annular cavity and a small gear installation position. The rotating assembly includes: a large gear rotatably disposed in the annular cavity and a knob support ring. The inner support assembly is disposed on an upper side of the rotating assembly and connected to the bottom housing. The rotating assembly is capable of rotating at a lower side of the inner support assembly. The small gear is installed on the small gear installation position and meshes with the large gear. The permanent magnet is installed in the small gear. The PCBA is installed on the inner support assembly and includes a magnetic induction module matched with the permanent magnet.

### TECHNICAL FIELD

The present disclosure relates to the technical field of potentiometers, in particular to an intelligent knob.

### BACKGROUND

Knob switch is a component controlled by hand, and can be rotated continuously or rotated in a specific angle based on functional requirements. Many household appliances in the market are equipped with knob switches, such as gas stoves, water heaters, microwave ovens, induction cookers, and other appliances. The intelligent knob is a knob switch with a display function and function switching. Compared with a traditional knob for a traditional stove, the intelligent knob can display a switch state and functions on a display screen, allowing users to intelligently control the operation of electrical appliances.

Referring to a China patent document with a publication number of CN218995947U, which discloses an encoder knob module with a display function. The encoder knob includes: a bottom shell, an encoder, a display module, a circuit board, a knob and a sealing ring; the bottom shell is provided with an open accommodating groove; the encoder is accommodated in the accommodating groove, the encoder includes: a fixed part and a rotating part arranged on the periphery of the fixed part, and the fixed part and the bottom shell are relatively fixed; the display module is fixed relative to the bottom shell and covers the notch of the accommodating groove; the circuit board is accommodated in the accommodating groove and is electrically connected with the encoder and the display module; the knob is connected with the rotating part of the encoder, and the part, exposed outwards relative to the containing groove, of the knob is arranged on the periphery of the display module in a surrounding mode; and the sealing ring is arranged between the bottom shell and the knob, and is clamped by the bottom shell and the knob together. However, the patent requires the encoder to convert mechanical rotation signals into electrical signals for output, and the problem is that: (1) the encoder usually uses an electric brush to electrically contact an encoder contact chip to output encoding signals; and after long-term use, it is easy to cause significant wear on the contact points and insufficient lifespan; (2) the encoder has many components, a complex structure, cumbersome assembly, and high costs; and (3) the encoder uses the electrical brush to contact conductive or insulating areas on the encoder contact chip to achieve binary code (1 and 0) output; however, the number of conductive and insulating areas on the encoder contact chip is easily limited (usually, the number of conductive and insulating areas is less than 20), and thus the number of encoded signals is limited.

Referring to a China patent document with a publication number of CN204557140U, which discloses a knob formula wireless intelligence gas-cooker switch; the knob formula wireless intelligence gas-cooker switch includes a knob, a base, and a gas-cooker switch shaft; a lower surface of the knob is eccentrically provided with a magnet; and four magnetic induction devices are installed inside the base around the gas-cooker switch shaft to sense a position of the magnet. However, this patent requires the use of four magnetic induction devices combined with the magnet to determine a rotary state of the knob. The magnetic induction devices and the magnet occupy a large space, making it difficult to install display modules, button switches, and other components. Additionally, this patent can only provide electrical signal outputs for eight rotation angles, and the costs of the four magnetic induction devices are relatively high.

### SUMMARY

To solve the above technical problems, the present disclosure is to provide an intelligent knob for outputting electrical signals through magnetic induction. There is no contact and abrasion between a magnetic induction module of the intelligent knob and a permanent magnet. The intelligent knob has a long service life. Structures used to drive the rotation of the permanent magnet of the intelligent knob are relatively simple, easy to assemble, and have low costs. The intelligent knob only requires one permanent magnet to cooperate with one magnetic induction module to achieve a rotation electrical signal output of the intelligent knob, and the number of encoded signals is not limited, making the control of various functions of the intelligent knob easier.

A technical solution of the present disclosure is:
an intelligent knob, including: a bottom housing, a rotating assembly, an inner support assembly, a small gear, a printed circuit board assembly (PCBA), a display module, a knob outer ring, and a permanent magnet; wherein an upper side of the bottom housing defines an annular cavity and a small gear installation position; the rotating assembly comprises: a large gear and a knob support ring that are connected to each other; the large gear is rotatably disposed in the annular cavity, and the knob support ring is rotatably installed on the bottom housing; the inner support assembly is disposed on an upper side of the rotating assembly, the rotating assembly is capable of rotating on a lower side of the inner support assembly, and the inner support assembly is connected to the bottom housing; the small gear is rotatably installed on the small gear installation position, and the small gear is meshed with the large gear of the rotating assembly; the permanent magnet is installed in an upper end of the small gear; the PCBA is installed on the inner support assembly; the PCBA comprises: a magnetic induction module, and the magnetic induction module is matched with the permanent magnet through magnetic induction; the display module is installed on the inner support assembly, and the knob outer ring is rotatably sleeved on the display module; and a lower end of the knob outer ring is connected to the knob support ring of the rotating assembly.

In an embodiment, the large gear of the rotating assembly is an internal gear, and the small gear installation position is defined at an inner ring position of the annular cavity; an outer side of the large gear is provided with an outer ripple, and an outer ring position of the annular cavity is provided with an elastic sheet; the elastic sheet elastically contacts and fits with the outer ripple of the large gear; a side of the elastic sheet is provided with a convex head; and the convex head elastically presses against an outer side of the outer ripple.

In an embodiment, the intelligent knob further comprises: a gear shaft; the gear shaft is vertically installed on the small gear installation position of the bottom housing, and a shaft hole is defined at a lower end of the small gear; an upper end of the gear shaft is inserted into the shaft hole; the upper end of the small gear is provided with a cylinder, and the permanent magnet is installed in the cylinder; the inner support assembly defines a cylinder through-hole, and the cylinder is rotatably inserted into the cylinder through-hole; the cylinder through-hole corresponds to the magnetic induction module in positions; and the magnetic induction module is packaged as an integrated circuit chip.

In an embodiment, an upper side of the inner support assembly defines a circuit board installation chamber, and the PCBA is fixedly installed in the circuit board installation chamber.

In an embodiment, the display module includes a display module support part, a display screen, and a glass cover plate; an outer periphery of the upper side of the inner support assembly is provided with multiple support blocks; the display module support part is installed on the multiple support blocks; a middle of the display module support part defines a display screen positioning chamber, and the display screen is installed in the display screen positioning chamber; a flexible printed circuit (FPC) is connected between the display screen and the PCBA; an overall shape of the display screen and the display screen positioning chamber is circular or rectangular; and the glass cover plate is installed on an upper side of the display module support part.

In an embodiment, the display module includes a display module support part, a digital display board, and a glass cover plate; an outer periphery of the upper side of the inner support assembly is provided with multiple support blocks; the display module support part is installed on the multiple support blocks; the digital display board is integrally connected to a middle of the display module support part; the digital display board is provided with a digital display thereon; wires are connected between the digital display and the PCBA; and the glass cover plate is installed on an upper side of the display module support part.

In an embodiment, the rotating assembly is made of a transparent material, and multiple light emitting diodes (LEDs) are evenly arranged around an outer periphery of the PCBA; and the multiple LEDs are configured to emit lights and transmit the lights outwards through the rotary knob support ring of the rotating assembly.

In an embodiment, the knob support ring of the rotating assembly is provided with a circular support platform thereon, and the circular support platform is provided with support platform hooks thereon; a lower end of the knob outer ring is disposed on the circular support platform; an inner side of the knob outer ring defines knob grooves; and the support platform hooks are snapped with the knob grooves respectively.

In an embodiment, the intelligent knob further comprises: a fixing part and a spring assembly; a middle of the bottom housing defines a middle hole; a lower end of the inner support assembly is vertically provided with a sleeve; the sleeve is inserted in the middle hole and is detachably connected to the middle hole; the fixing part is movably inserted in the sleeve; a height of the fixing part is greater than a height of the sleeve, and the sleeve is configured to allow the inner support assembly to move outside the fixing part; a lower end of the PCBA is provided with a function button, the function button is matched with the fixing part, and the function button is configured to press the fixing part; and the spring assembly is disposed between the fixing part and the PCBA.

In an embodiment, a lower end of the fixing part defines multiple connection holes, and the multiple connection holes are configured to fix the fixing part to an external mechanism; a through-hole is defined in the fixing part, and the through-hole is configured to allow wires to be connected to the PCBA through the through-hole; a middle of an upper end of the fixing part is provided with a circular protrusion, the circular protrusion is matched with the function button, and the function button is configured to press the circular protrusion; the spring assembly includes a spring base and a spring; the spring base is installed under the PCBA, and the spring base is sleeved on the function button; an upper end of the spring is sleeved on the spring base, and a lower end of the spring is sleeved on the circular protrusion; an outer side of the upper end of the fixing part is provided with first anti-detachment blocks, and an inner side of the sleeve of the inner support assembly is provided with second anti-detachment blocks; and the first anti-detachment blocks are matched with the second anti-detachment blocks respectively in a snap fit, thereby preventing the sleeve from detaching upwards along the fixing part.

The beneficial effects of the present disclosure are as follows. The present disclosure uses the permanent magnet in conjunction with the magnetic induction module of the PCBA to achieve the output of electrical signals through magnetic induction. There is no contact and abrasion between the magnetic induction module of the intelligent knob and the permanent magnet, and thus the intelligent knob has a long service life. In the intelligent knob of the present disclosure, the upper side of the bottom housing defines the annular cavity and the small gear installation position; the rotating assembly includes the large gear and the knob support ring that are connected to each other; the large gear is rotatably disposed in the annular cavity, and the knob support ring is rotatably installed on the bottom housing; the inner support assembly is disposed on the upper side of the rotating assembly, the rotating assembly is capable of rotating on the lower side of the inner support assembly, and the inner support assembly is connected to the bottom housing; the small gear is rotatably installed on the small gear installation position, and the small gear is meshed with the large gear of the rotating assembly; the permanent magnet is installed in the upper end of the small gear; the PCBA is installed on the inner support assembly; the magnetic induction module is matched with the permanent magnet through magnetic induction; and the lower end of the knob outer ring is connected to the knob support ring of the rotating assembly. Therefore, when the knob outer ring is rotated, it can drive the rotating assembly to rotate. Then, the large gear of the rotating assembly drives the small gear to rotate, and the small gear drives the permanent magnet to rotate. Finally, the magnetic induction module senses the rotation of the permanent magnet and outputs an electrical signal. Structures used to drive the rotation of the permanent magnet of the intelligent knob are relatively simple, easy to assemble, and have low costs. The intelligent knob only requires one permanent magnet to cooperate with one magnetic induction module to achieve a rotation electrical signal output of the intelligent knob (i.e., the magnetic induction module can sense the rotation of the permanent magnet and output an electrical signal), and the number of encoded signals is not limited, making the control of various functions of the intelligent knob easier.

### BRIEF DESCRIPTION OF DRAWINGS

FIG. 1 illustrates a first overall structural diagram of an intelligent knob.

FIG. 2 illustrates a second overall structural diagram of the intelligent knob.

FIG. 3 illustrates a first exploded structural diagram of the intelligent knob.

FIG. 4 illustrates a second exploded structural diagram of the intelligent knob.

FIG. 5 illustrates a sectional structural diagram of the intelligent knob.

FIG. 6 illustrates a structural diagram of a rectangular display screen and a display module support part.

FIG. 7 illustrates a structural diagram of a digital display board and a display module support part.

### DETAILED DESCRIPTION OF EMBODIMENTS

The following will provide a further detailed explanation of structures and working principles of the present disclosure in conjunction with the drawings.

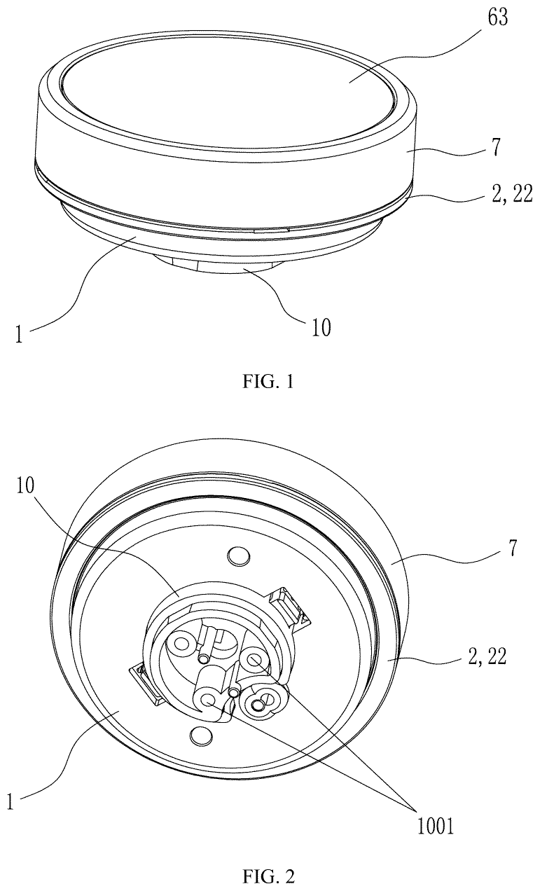

Referring to FIG. 1 to FIG. 5, the present disclosure provides an intelligent knob. The intelligent knob includes a bottom housing 1, a rotating assembly 2, an inner support assembly 3, a small gear 4, a printed circuit board assembly (PCBA) 5, a display module 6, a knob outer ring 7, and a permanent magnet 8. An upper side of the bottom housing 1 defines an annular cavity 101 and a small gear installation position 102. The rotating assembly 2 includes a large gear 21 and a knob support ring 22 that are connected to each other. The large gear 21 is rotatably disposed in the annular cavity 101, and the knob support ring 22 is rotatably installed on the bottom housing 1. The inner support assembly 3 is disposed on an upper side of the rotating assembly 2, the rotating assembly 2 is capable of rotating on a lower side of the inner support assembly 3, and the inner support assembly 3 is connected to the bottom housing 1. The small gear 4 is rotatably installed on the small gear installation position 102, and the small gear 4 is meshed with the large gear 21 of the rotating assembly 2; the permanent magnet 8 is installed in an upper end of the small gear 4. The PCBA 5 is installed on the inner support assembly 3. The PCBA 5 includes a magnetic induction module 51, and the magnetic induction module 51 is matched with the permanent magnet 8 through magnetic induction. The display module 6 is installed on the inner support assembly 3, and the knob outer ring 7 is rotatably sleeved on the display module 6. A lower end of the knob outer ring 7 is connected to the knob support ring 22 of the rotating assembly 2. An upper end of the knob outer ring 7 includes a limit buckle 72 to prevent the display module 6 from detaching upwards. The present disclosure uses the permanent magnet 8 in conjunction with the magnetic induction module 51 of the PCBA 5 to achieve the output of electrical signals through magnetic induction. There is no contact and abrasion between the magnetic induction module 51 of the intelligent knob and the permanent magnet 8, and thus the intelligent knob has a long service life. When the intelligent knob needs to be used, the knob outer ring 7 is rotated, and the knob outer ring 7 can drive the rotating assembly 2 to rotate; then, the large gear 21 of the rotating assembly 2 drives the small gear 4 to rotate, and the small gear 4 drives the permanent magnet 8 to rotate; finally, the magnetic induction module 51 senses the rotation of the permanent magnet 8 and outputs an electrical signal. Structures used to drive the rotation of the permanent magnet 8 of the intelligent knob are relatively simple, easy to assemble, and have low costs. The intelligent knob only requires one permanent magnet 8 to cooperate with one magnetic induction module 51 to achieve a rotation electrical signal output of the intelligent knob, and the number of encoded signals is not limited, making the control of various functions of the intelligent knob easier. The display module 6 of the intelligent knob is configured to display various functions and data, and thus the intelligent knob can display real-time numerical changes during a rotation operation.

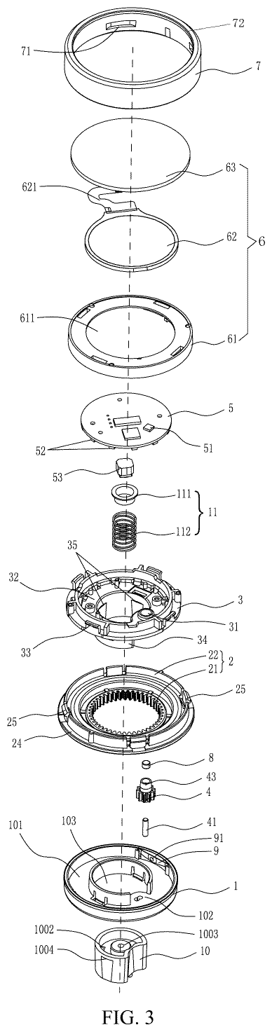

Referring to FIG. 3 to FIG. 5, the large gear 21 of the rotating assembly 2 is an internal gear, and the small gear installation position 102 is defined at an inner ring position of the annular cavity 101. An outer side of the large gear 21 includes an outer ripple 23, and an outer ring position of the annular cavity 101 is provided with an elastic sheet 9. The elastic sheet 9 elastically contacts and fits with the outer ripple 23 of the large gear 21. A side of the elastic sheet 9 is provided with a convex head 91. The convex head 91 elastically presses against an outer side of the outer ripple 23. Due to the elastic contact and fit between the outer ripple 23 and the elastic sheet 9, when a hand of a user rotates the intelligent knob, it has a good hand feel for the user. The user needs to slightly rotate the knob outer ring 7 by hand to make the convex head 91 of the elastic sheet 9 slide over each peak of the outer ripple 23, and the user can feel a process of the convex head 91 of the elastic sheet 9 sliding over each peak and valley of the outer ripple 23. When the user stops the rotation operation, the convex head 91 of the elastic sheet 9 will stay within a valley of the outer ripple 23, thereby preventing the rotating assembly 2 and the knob outer ring 7 from moving.

Referring to FIG. 3 to FIG. 5, the intelligent knob further includes a gear shaft 41. The gear shaft 41 is vertically installed on the small gear installation position 102 of the bottom housing 1, and a shaft hole 42 is defined at a lower end of the small gear 4. An upper end of the gear shaft 41 is inserted into the shaft hole 42. The upper end of the small gear 4 is provided with a cylinder 43, and the permanent magnet 8 is installed in the cylinder 43. The inner support assembly 3 defines a cylinder through-hole 31, and the cylinder 43 is rotatably inserted into the cylinder through-hole 31. The cylinder through-hole 31 corresponds to the magnetic induction module 51 in positions; and the magnetic induction module 51 is packaged as an integrated circuit chip. In some embodiments, the magnetic induction module 51 can be a hall component, and a shape of the permanent magnet 8 is cylindrical, an upper side of the cylindrical permanent magnet facing the magnetic induction module 51, and the magnetic field changes of the permanent magnet 8 can be sensed in real time by the hall component when the permanent magnet 8 is rotated.

Referring to FIG. 3 to FIG. 5, an upper side of the inner support assembly 3 defines a circuit board installation chamber 32, and the PCBA 5 is fixedly installed in the circuit board installation chamber 32.

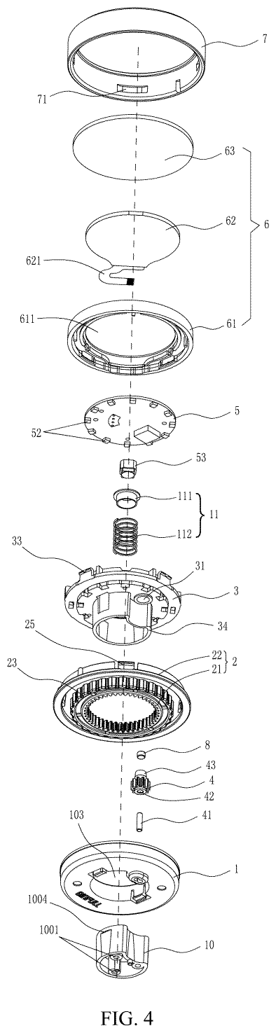

In an embodiment, referring to FIG. 3 to FIG. 5, the display module 6 includes a display module support part 61, a display screen 62, and a glass cover plate 63. An outer periphery of the upper side of the inner support assembly 3 is provided with multiple support blocks 33. The display module support part 61 is installed on the multiple support blocks 33. A middle of the display module support part 61 defines a display screen positioning chamber 611, and the display screen 62 is installed in the display screen positioning chamber 611. A flexible printed circuit (FPC) 621 is connected between the display screen 62 and the PCBA 5. In an embodiment, referring to FIG. 3, an overall shape of the display screen 62 and the display screen positioning chamber 611 is circular. In an embodiment, referring to FIG. 4, an overall shape of the display screen 62 and the display screen positioning chamber 611 is rectangular. The glass cover plate 63 is installed on an upper side of the display module support part 61.

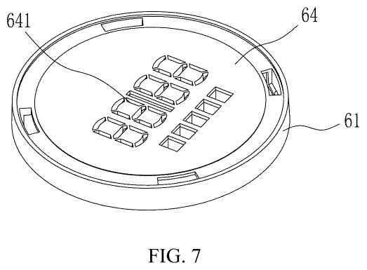

In an embodiment, referring to FIG. 3, FIG. 4, and FIG. 7, another structure of the display module 6 includes a display module support part 61, a digital display board 64, and a glass cover plate 63. The difference between the display module 6 in FIG. 6 and the display module in FIG. 7 is that the display module support 61 and display screen 62 in FIG. 3 and FIG. 4 are replaced with the display module support 61 and the digital display board 64 in FIG. 7. An outer periphery of the upper side of the inner support assembly 3 is provided with multiple support blocks 33. The display module support part 61 is installed on the multiple support blocks 33. The digital display board 64 is integrally connected to a middle of the display module support part 61. The digital display board 64 is provided with a digital display 641 thereon. Wires are connected between the digital display 641 and the PCBA 5. The glass cover plate 63 is installed on an upper side of the display module support part 61.

Referring FIG. 1 to FIG. 5, the rotating assembly 2 is made of a transparent material, and multiple light emitting diodes 52 (LEDs) are evenly arranged around an outer periphery of the PCBA 5. The multiple LEDs 52 are configured to emit lights and transmit the lights outwards through the rotary knob support ring 22 of the rotating assembly 2. After the intelligent knob is rotated, the knob support ring 22 will display a circle of ambient lighting, thereby forming a good visual effect.

Referring to FIG. 3 to FIG. 5, the knob support ring 22 of the rotating assembly 2 is provided with a circular support platform 24 thereon, and the circular support platform 24 is provided with support platform hooks 25 thereon. A lower end of the knob outer ring 22 is disposed on the circular support platform 24. An inner side of the knob outer ring 22 defines knob grooves 71, and the support platform hooks 25 are snapped with the knob grooves 71 respectively. In addition, the knob outer ring 7 is made of metal.

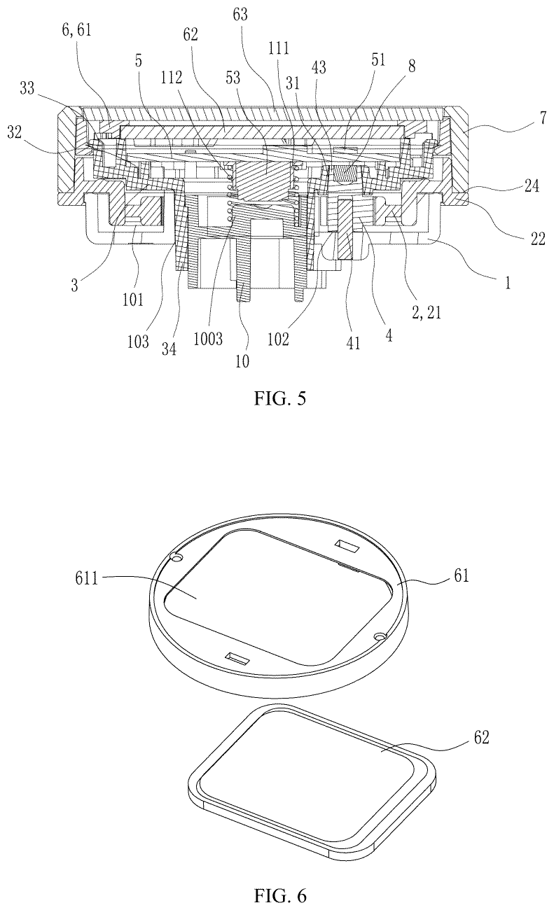

Referring to FIG. 1 to FIG. 5, the intelligent knob further includes a fixing part 10, and a spring assembly 11. A middle of the bottom housing 1 defines a middle hole 103. A lower end of the inner support assembly 3 is vertically provided with a sleeve 34. The sleeve 34 is inserted in the middle hole 103 and is detachably connected to the middle hole 103; The fixing part 10 is movably inserted in the sleeve 34. A height of the fixing part 10 is greater than a height of the sleeve 34, and the sleeve 34 is configured to allow the inner support assembly 3 to move outside the fixing part 10. A lower end of the PCBA 5 is provided with a function button 53, the function button 53 is matched with the fixing part 10, and the function button 53 is configured to press the fixing part 10. The spring assembly 11 is disposed between the fixing part 10 and the PCBA 5. The lower end of fixing part 10 is configured to be fixed on a mechanical component of a gas stove, a water heater, a microwave, an induction cooker, or other electrical appliances, as shown in FIG. 5. When a user presses the glass cover plate 63 of the intelligent knob by hand, all components except for fixing part 10 will descend as a whole, and the upper end of the fixing part 10 will press the function button 53. When the user releases the pressure on the glass cover plate 63 of the intelligent knob, all components except for the fixing part 10 will rise as a whole under the elastic action of the spring assembly 11, and the upper end of the fixing part 10 will release the pressure on the function button 53. The intelligent knob has multiple functions, such as power, gear, time, etc., which can be switched or determined by pressing the function button 53, and the numerical value or control operation can be adjusted by rotating the rotating assembly 2.

Referring to FIG. 1 to FIG. 5, a lower end of the fixing part 10 defines multiple connection holes 1001, and the multiple connection holes 1001 are configured to fix the fixing part 10 to an external mechanism (not shown in the drawings). A through-hole 1002 is defined in the fixing part 10, and the through-hole 1002 is configured to allow wires (not shown in the drawings) to be connected to the PCBA 5 through the through-hole 1002. A middle of an upper end of the fixing part 10 is provided with a circular protrusion 1003, the circular protrusion 1003 is matched with the function button 53, and the function button 53 is configured to press the circular protrusion 1003. The spring assembly 11 includes a spring base 111 and a spring 112. The spring base 111 is installed under the PCBA 5, and the spring base 111 is sleeved on the function button 53. An upper end of the spring 112 is sleeved on the spring base 111, and a lower end of the spring 112 is sleeved on the circular protrusion 1003. An outer side of the upper end of the fixing part 10 is provided with first anti-detachment blocks 1004, and an inner side of the sleeve 34 of the inner support assembly 3 is provided with second anti-detachment blocks 35. The first anti-detachment blocks 1004 are matched with the second anti-detachment blocks 35 respectively in a snap fit, thereby preventing the sleeve 34 from detaching upwards along the fixing part 10.

The above embodiments are only exemplary embodiments of the present disclosure. Any minor modifications, equivalent changes, or modifications made to the above embodiments based on the technical solution of the present disclosure are within the scope of the technical solution of the present disclosure.

What is claimed is:

1. An intelligent knob, comprising: a bottom housing, a rotating assembly, an inner support assembly, a small gear, a printed circuit board assembly (PCBA), a display module, a knob outer ring, and a permanent magnet; wherein an upper side of the bottom housing defines an annular cavity and a small gear installation position; the rotating assembly comprises: a large gear and a knob support ring that are connected to each other; the large gear is rotatably disposed in the annular cavity, and the knob support ring is rotatably installed on the bottom housing; the inner support assembly is disposed on an upper side of the rotating assembly, the rotating assembly is capable of rotating on a lower side of the inner support assembly, and the inner support assembly is connected to the bottom housing; the small gear is rotatably installed on the small gear installation position, and the small gear is meshed with the large gear of the rotating assembly; the permanent magnet is installed in an upper end of the small gear; the PCBA is installed on the inner support assembly; the PCBA comprises: a magnetic induction module, and the magnetic induction module is matched with the permanent magnet through magnetic induction; the display module is installed on the inner support assembly, and the knob outer ring is rotatably sleeved on the display module; and a lower end of the knob outer ring is connected to the knob support ring of the rotating assembly.

2. The intelligent knob as claimed in claim 1, wherein the large gear of the rotating assembly is an internal gear, and the small gear installation position is defined at an inner ring position of the annular cavity; an outer side of the large gear is provided with an outer ripple, and an outer ring position of the annular cavity is provided with an elastic sheet; the elastic sheet elastically contacts and fits with the outer ripple of the large gear; a side of the elastic sheet is provided with a convex head; and the convex head elastically presses against an outer side of the outer ripple.

3. The intelligent knob as claimed in claim 1, wherein the intelligent knob further comprises: a gear shaft; the gear shaft is vertically installed on the small gear installation position of the bottom housing, and a shaft hole is defined at a lower end of the small gear; an upper end of the gear shaft is inserted into the shaft hole; the upper end of the small gear is provided with a cylinder, and the permanent magnet is installed in the cylinder; the inner support assembly defines a cylinder through-hole, and the cylinder is rotatably inserted into the cylinder through-hole; the cylinder through-hole corresponds to the magnetic induction module in positions; and the magnetic induction module is packaged as an integrated circuit chip.

4. The intelligent knob as claimed in claim 1, wherein an upper side of the inner support assembly defines a circuit board installation chamber, and the PCBA is fixedly installed in the circuit board installation chamber.

5. The intelligent knob as claimed in claim 4, wherein the display module comprises: a display module support part, a display screen, and a glass cover plate; an outer periphery of the upper side of the inner support assembly is provided with a plurality of support blocks; the display module support part is installed on the plurality of support blocks; a middle of the display module support part defines a display screen positioning chamber, and the display screen is installed in the display screen positioning chamber; a flexible printed circuit (FPC) is connected between the display screen and the PCBA; an overall shape of the display screen and the display screen positioning chamber is circular or rectangular; and the glass cover plate is installed on an upper side of the display module support part.

6. The intelligent knob as claimed in claim 4, wherein the display module comprises: a display module support part, a digital display board, and a glass cover plate; an outer periphery of the upper side of the inner support assembly is provided with a plurality of support blocks; the display module support part is installed on the plurality of support blocks; the digital display board is integrally connected to a middle of the display module support part; the digital display board is provided with a digital display thereon; wires are connected between the digital display and the PCBA; and the glass cover plate is installed on an upper side of the display module support part.

7. The intelligent knob as claimed in claim 1, wherein the rotating assembly is made of a transparent material, and a plurality of light emitting diodes (LEDs) are evenly arranged around an outer periphery of the PCBA; and the plurality of LEDs are configured to emit lights and transmit the lights outwards through the rotary knob support ring of the rotating assembly.

8. The intelligent knob as claimed in claim 1, wherein the knob support ring of the rotating assembly is provided with a circular support platform thereon, and the circular support platform is provided with support platform hooks thereon; a lower end of the knob outer ring is disposed on the circular support platform; an inner side of the knob outer ring defines knob grooves; and the support platform hooks are snapped with the knob grooves respectively.

9. The intelligent knob as claimed in claim 1, wherein the intelligent knob further comprises: a fixing part and a spring assembly; a middle of the bottom housing defines a middle hole; a lower end of the inner support assembly is vertically provided with a sleeve; the sleeve is inserted in the middle hole and is detachably connected to the middle hole; the fixing part is movably inserted in the sleeve; a height of the fixing part is greater than a height of the sleeve, and the sleeve is configured to allow the inner support assembly to move outside the fixing part; a lower end of the PCBA is provided with a function button, the function button is matched with the fixing part, and the function button is configured to press the fixing part; and the spring assembly is disposed between the fixing part and the PCBA.

10. The intelligent knob as claimed in claim 9, wherein a lower end of the fixing part defines a plurality of connection holes, and the plurality of connection holes are configured to fix the fixing part to an external mechanism; a through-hole is defined in the fixing part, and the through-hole is configured to allow wires to be connected to the PCBA through the through-hole; a middle of an upper end of the fixing part is provided with a circular protrusion, the circular protrusion is matched with the function button, and the function button is configured to press the circular protrusion; the spring assembly comprises: a spring base and a spring; the spring base is installed under the PCBA, and the spring base is sleeved on the function button; an upper end of the spring is sleeved on the spring base, and a lower end of the spring is sleeved on the circular protrusion; an outer side of the upper end of the fixing part is provided with first anti-detachment blocks, and an inner side of the sleeve of the inner support assembly is provided with second anti-detachment blocks; and the first anti-detachment blocks are matched with the second anti-detachment blocks respectively in a snap fit, thereby preventing the sleeve from detaching upwards along the fixing part.
